(19) United States
(12) Patent Application Publication
(10) Pub. No.: US 2025/0233272 A1
(43) Pub. Date: Jul. 17, 2025

(54) TAB, BATTERY MODULE, AND BATTERY PACK

(71) Applicant: MURATA MANUFACTURING CO., LTD., Kyoto (JP)

(72) Inventor: Yoshiyuki BANNAI, Kyoto (JP)

(21) Appl. No.: 19/013,542

(22) Filed: Jan. 8, 2025

(30) Foreign Application Priority Data
Jan. 16, 2024 (JP) 2024-004706

(51) Int. Cl. H01M 50/503; H01M 50/244; H01M 50/583

(52) U.S. Cl. CPC H01M 50/503; H01M 50/244; H01M 50/583; H01M 2200/103

(57) ABSTRACT

A tab is provided and includes a first tab portion; a second tab portion; a connecting portion that connects the first tab portion and the second tab portion; and a heat shrinkable member that covers the connecting portion, at least a part of the first tab portion, and at least a part of the second tab portion, wherein in a case where a direction in which the first tab portion and the second tab portion are arranged is an X direction, a thickness direction of the first tab portion and the second tab portion is a Z direction, and a direction perpendicular to each of the X direction and the Z direction is a Y direction, a dimension of the connecting portion in the Y direction is smaller than a dimension of the first tab portion in the Y direction and a dimension of the second tab portion in the Y direction, and the first tab portion and the second tab portion are non-line symmetrical as viewed along the Z direction with respect to an imaginary line extending in the Y direction through a center of the connecting portion, and/or non-line symmetrical as viewed along the Y direction with respect to an imaginary line extending in the Z direction through a center of the connecting portion.

### CROSS REFERENCE TO RELATED APPLICATIONS

The present application claims priority to Japanese patent application no. 2024-004706, filed on Jan. 16, 2024, the entire contents of which is incorporated herein by reference.

### BACKGROUND

The present disclosure relates to a tab, a battery module, and a battery pack.

A bus bar is disclosed with a fuse function that has a rectangular flat plate shape made of a conductive material, has a center formed in a concave shape with respect to the plate thickness, has a narrowed portion narrowed with respect to the plane, and has a heat-resistant heat-shrinkable tube which covers the periphery thereof.

### SUMMARY

The bus bar with the fuse function described in the Background section has a shape that is line-symmetric in plan view with respect to an imaginary line extending in the long side direction (and the short side direction) of the rectangular flat plate through the center of the narrowed portion, and line-symmetric in side view with respect to an imaginary line extending in the thickness direction of the rectangle through the center of the narrowed portion.

In a case where an abnormally large current flows to the bus bar and the narrowed portion is fused, scattering of generated metal vapor or molten metal is prevented by the heat-resistant heat-shrinkable tube, but application of an external force caused by fusing inside the heat-resistant heat-shrinkable tube, contact of the molten metal in the narrowed portion, and the like may occur, and the fused narrowed portion may come into contact again, and there is room for improvement in re-contact of the fused portions.

The present disclosure, in an embodiment, has been made in view of such a viewpoint. In an embodiment, the present disclosure relates to providing a tab, a battery module, and a battery pack that prevent re-contact of fused portions when an overcurrent flows and a fuse is fused.

The tab of the present disclosure includes: a first tab portion; a second tab portion; a connecting portion that connects the first tab portion and the second tab portion; and a heat shrinkable member that covers the connecting portion, at least a part of the first tab portion, and at least a part of the second tab portion, wherein in a case where a direction in which the first tab portion and the second tab portion are arranged is an X direction, a thickness direction of the first tab portion and the second tab portion is a Z direction, and a direction perpendicular to each of the X direction and the Z direction is a Y direction, a dimension of the connecting portion in the Y direction is smaller than a dimension of the first tab portion in the Y direction and a dimension of the second tab portion in the Y direction, and the first tab portion and the second tab portion are non-line symmetrical as viewed along the Z direction with respect to an imaginary line extending in the Y direction through a center of the connecting portion, and/or non-line symmetrical as viewed along the Y direction with respect to an imaginary line extending in the Z direction through a center of the connecting portion.

The battery module of the present disclosure includes the above-described tab.

The battery pack of the present disclosure includes the above-described battery module.

According to the present disclosure, when an overcurrent flows and the connecting portion connecting the first tab portion and the second tab portion is fused, it is possible to prevent re-contact of the fused portions.

### BRIEF DESCRIPTION OF THE FIGURES

FIG. 1 is a schematic exploded perspective view of a battery pack of the present disclosure;

FIG. 2 is a schematic exploded perspective view of a battery module housed in the battery pack of the present disclosure;

FIG. 3 is a schematic perspective view of a tab of an embodiment;

FIG. 4A is a schematic plan view of a tab (in which a heat shrinkable member is not illustrated) of an embodiment;

FIG. 4B is a schematic plan view of the tab of an embodiment;

FIG. 5 is a schematic plan view for explaining a case where fusing occurs in the tab of an embodiment;

FIG. 6 is a schematic plan view of a modification of the tab of an embodiment;

FIG. 7A is a schematic perspective view of a modification of the battery module based on the tab of an embodiment;

FIG. 7B is a schematic plan view of a modification of the battery module based on the tab of an embodiment;

FIG. 8 is a schematic plan view of an additional modification of the battery module based on the tab of an embodiment;

FIG. 9A is a schematic perspective view of an additional modification of the battery module based on the tab of an embodiment;

FIG. 9B is a schematic plan view of an additional modification of the battery module based on the tab of an embodiment;

FIG. 9C is a schematic plan view for explaining a case where fusing occurs in the tab in the battery module shown in FIG. 9B;

FIG. 10A is a schematic perspective view of a tab of an embodiment;

FIG. 10B is a schematic plan view of the tab of an embodiment;

FIG. 11A is a schematic side view of the tab of an embodiment;

FIG. 11B is a schematic side view for explaining a case where fusing occurs in the tab of an embodiment;

FIG. 12A is a schematic plan view of a modification of the tab of an embodiment;

FIG. 12B is a schematic plan view of an additional modification of the tab of an embodiment;

FIG. 12C is a schematic plan view of an additional modification of the tab of an embodiment;

FIG. 12D is a schematic plan view of an additional modification of the tab of an embodiment;

FIG. 12E is a schematic plan view of an additional modification of the tab of an embodiment;

FIG. 12F is a schematic plan view of an additional modification of the tab of an embodiment;

FIG. 12G is a schematic plan view of an additional modification of the tab of an embodiment;

FIG. 12H is a schematic plan view of an additional modification of the tab of an embodiment;

FIG. 12I is a schematic plan view of an additional modification of the tab of an embodiment;

FIG. 12J is a schematic plan view of an additional modification of the tab of an embodiment;

FIG. 12K is a schematic plan view of an additional modification of the tab of an embodiment; and

FIG. 12L is a schematic plan view of an additional modification of the tab of an embodiment.

### DETAILED DESCRIPTION

Hereinafter, a tab, a battery module, and a battery pack according to an embodiment of the present disclosure will be described in more detail. Although description will be made with reference to the drawings as necessary, various elements in the drawings are merely schematically and exemplarily shown for understanding of the present disclosure, and appearance and a dimensional ratio and the like can be different from those of actual ones.

The “Z direction” in the present specification refers to a thickness direction of an object (for example, a battery pack), and a drawing viewed from the Z direction is assumed to be a plan view. The “Y direction” refers to a height direction of a battery used in a battery pack, and a drawing viewed from the Y direction is assumed to be a side view. The “X direction” refers to a direction orthogonal to the Z direction and the Y direction. That is, the X direction, the Y direction, and the Z direction are intended to be orthogonal to each other. Although the X direction, the Y direction, and the Z direction are illustrated in the drawings, the direction of an arrow is intended to be a positive direction (or the +direction), and the direction opposite to the direction of the arrow is intended to be a negative direction (or the −direction). Further, a term such as “about” means that it may include variation of a few percent, for example, +10%.

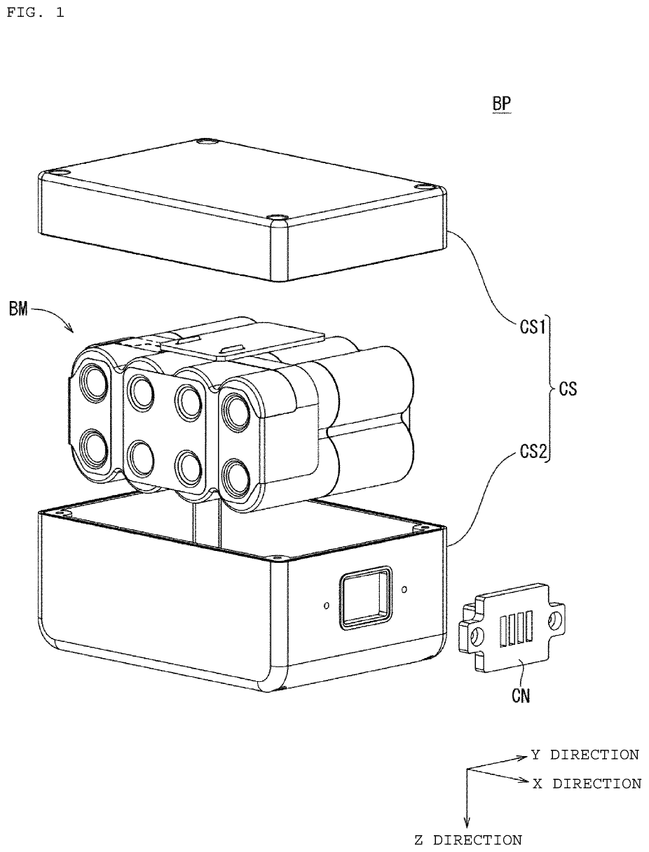

A battery pack BP of the present disclosure will be described with reference to FIG. 1. FIG. 1 is a schematic exploded perspective view of the battery pack BP.

The battery pack BP may include a case CS and a battery module BM housed in the case CS (see FIG. 1). The detailed description of the battery module BM will be described later with reference to items.

The case CS may include a first case CS1 and a second case CS2. The first case CS1 and the second case CS2 may form a housing space for housing the battery module BM. In the example of FIG. 1, an aspect in which the housing space includes two cases (the first case CS1 and the second case CS2) is exemplified, but the present invention is not limited to this aspect, and the housing space may be include three or more cases.

A material of the case CS may be any material, and may be a resin material (for example, plastic) or a metal material. Examples of the resin material include polycarbonate resin (PC), acrylonitrile-butadiene-styrene resin (ABS), polybutylene terephthalate resin (PBT), modified polyphenylene ether resin (m-PPE), and polyamide resin (PA). Examples of the metal material include aluminum. From the viewpoint of more suitably housing the battery module BM, a material having high rigidity may be used for the case CS.

The case CS may be provided with a connector CN electrically connected to the battery module BM. The example illustrated in FIG. 1 illustrates an aspect in which the connector CN is provided in the second case CS2, but the connector CN may be provided in the first case CS1. The connector CN may be a terminal for extracting electric power from the battery module BM.

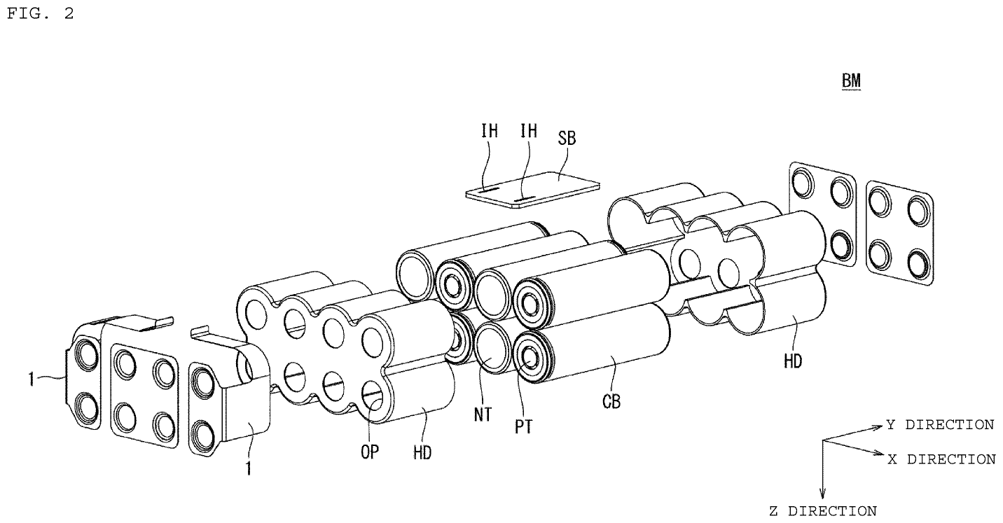

The battery module BM of the present disclosure will be described with reference to FIG. 2. FIG. 2 is a schematic exploded perspective view of the battery module BM housed in the battery pack BP of the present disclosure.

The battery module BM of the present disclosure may include a battery CB, a battery holder HD, a tab 1, and a control board SB. Hereinafter, each configuration will be described in detail.

The battery CB is intended to be a chemical battery that mainly converts chemical energy into direct current power by a chemical reaction. The battery CB used in the battery module BM of the present disclosure is intended to be a cylindrical battery having a cylindrical axis in the +Y direction. The shape of the battery may be a shape other than the cylindrical shape (for example, an elliptical cylindrical shape, a rectangular columnar shape, a polygonal columnar shape, or the like).

In the battery module BM of the present disclosure, two or more batteries CB may be provided. Each battery CB may be disposed adjacent to one another. For example, in the aspect shown in FIG. 2, the four batteries CB may be arranged so as to be adjacent to each other in the +X direction, and may be stacked in the +Z direction to form two rows. The number of batteries and the stacking pattern are not limited to those in FIG. 2.

The battery holder HD may be a member that holds and/or fixes the battery CB in the housing space of the case CS. In FIG. 2 illustrating an example, the battery holder HD is provided on the +Y direction side and the −Y direction side of the battery CB. That is, the battery holder HD accommodates the battery CB so as to sandwich the battery CB from both sides in the #Y direction, and holds and/or fixes the battery CB. In the aspect illustrated in FIG. 2, the battery holder HD includes two members so as to sandwich the battery CB from both sides in the +Y direction, but the battery holder HD may include three or more members. In addition, the battery holder HD may be formed as a single member, and the battery CB may be held and/or fixed by inserting the battery CB from the +Y direction or the −Y direction to the battery holder HD.

As illustrated in FIG. 2, the battery holder HD may be provided with an opening OP through which a positive terminal and a negative terminal of the battery CB are exposed. The battery CB (positive terminal and negative terminal) may be electrically connected to the tab 1 through the opening OP.

As illustrated in FIG. 2, the tab 1 may be provided so as to sandwich the battery CB in the +Y direction. The tab 1 may electrically connect the positive terminal PT and/or the negative terminal NT of adjacent batteries CB to each other. In FIG. 2 illustrating an example, the tab 1 may electrically connect the batteries CB in parallel by electrically connecting the positive terminals PT (or the negative terminals NT) of the batteries CB adjacent in the +Z direction to each other. In FIG. 2 illustrating an example, the tab 1 may electrically connect the batteries CB in series by electrically connecting the positive terminal PT and the negative terminal NT of the batteries CB adjacent in the +X direction. The detailed description of the tab 1 will be given later. As described later, the tab 1A of the first embodiment or the tab 1B of the second embodiment may be adopted as the tab 1 of the present disclosure.

The control board SB may be disposed on the outer surface of the battery holder HD in FIG. 2 illustrating an example. The control board SB may be provided with an insertion hole IH into which the tab 1 is inserted. As a result, power may be input to the control board SB from the battery CB via the tab 1 connected through the insertion hole IH. In addition, the power output from the battery CB via the tab 1 may be controlled.

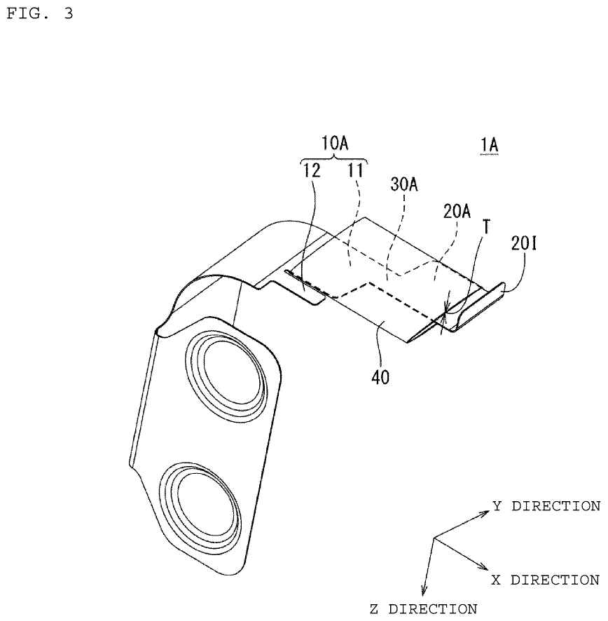

The tab 1A of the first embodiment will be described with reference to FIGS. 3 to 9B. The tab 1A of the present embodiment includes a first tab portion 10A, a second tab portion 20A, a connecting portion 30A, and a heat shrinkable member 40.

The first tab portion 10A is a portion electrically connected to a positive terminal PT or a negative terminal NT of the battery CB, and may have conductivity. The term “conductivity” as used herein means that the volume resistivity is 105 Ω·cm or less. The second tab portion 20A is a portion electrically connected to the control board SB, and may have conductivity. The second tab portion 20A may have an insertion portion 20I to be inserted into the insertion hole IH of the control board SB described above. The insertion portion 20I extends in the +Z direction, and the insertion portion 20I and the control board SB may be electrically connected. The first tab portion 10A and the second tab portion 20A are arranged side by side in the X direction.

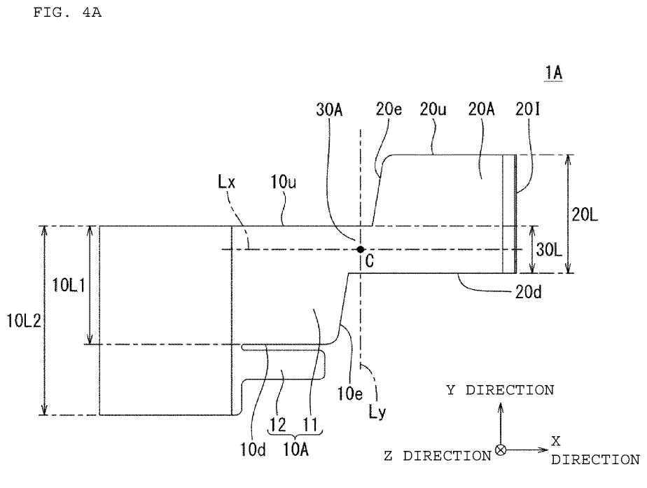

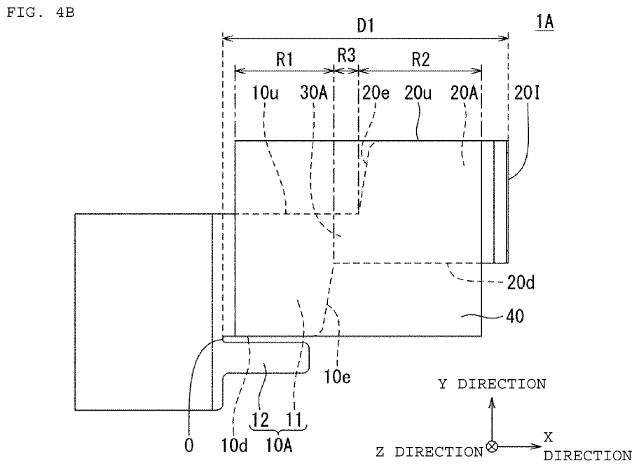

The connecting portion 30A is a portion that connects the first tab portion 10A and the second tab portion 20A. As shown in FIG. 4A, a dimension 30L of the connecting portion 30A in the Y direction is smaller than a dimension 1011 of the first tab portion 10A in the Y direction and a dimension 20L of the second tab portion 20A in the Y direction. According to such a connecting portion 30A, the connecting portion 30A can be fused by an overcurrent flowing therethrough to function as a fuse.

The heat shrinkable member 40 is a member that covers the connecting portion 30A, at least a part of the first tab portion 10A, and at least a part of the second tab portion 20A. Specifically, the heat shrinkable member 40 is a member having a hollow section as viewed along the +X direction in FIG. 4B, and the connecting portion 30A, at least a part of the first tab portion 10A, and at least a part of the second tab portion 20A are disposed in the hollow. According to such a coating aspect of the heat shrinkable member 40, when an overcurrent flows and the connecting portion 30A is fused, a spark (metal vapor or molten metal) at the time of fusing can be trapped by the heat shrinkable member.

In addition, in a case where heat due to overcurrent at the time of fusing is applied, the heat shrinkable member 40 can generate shrinkage stress in a direction toward the inside of the hollow-shaped heat shrinkable member 40 (in other words, in the direction toward the first tab portion 10A, the second tab portion 20A, and the connecting portion 30A arranged in the hollow of the hollow-shaped heat shrinkable member 40, or in the +Y direction and the +Z direction in the example of FIG. 4B). As an example of such the heat shrinkable member 40, a member made of a material such as vinyl chloride, silicon rubber, or fluorine-based polymer can be exemplified.

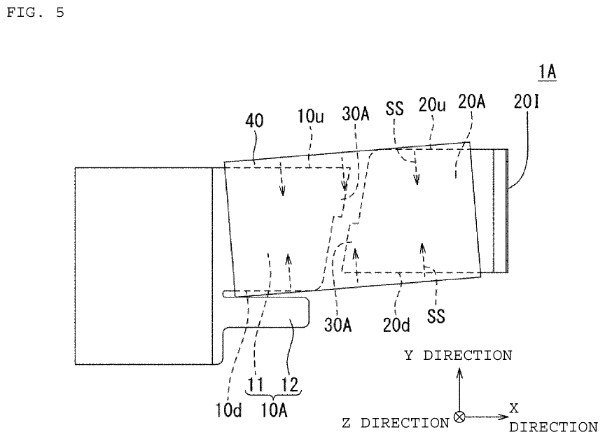

Here, in the tab 1A of the present embodiment, in a broad sense, the first tab portion 10A and the second tab portion 20A are non-line symmetrical as viewed along the Z direction with respect to an imaginary line Ly extending in the Y direction through the center C of the connecting portion 30A. As illustrated in FIG. 5, in a case where an overcurrent flows through the tab 1A and the connecting portion 30A is fused, heat shrinkage of the heat shrinkable member 40 occurs due to heat caused by the overcurrent. As a result, a shrinkage stress SS is applied in a direction in which the fused portion of the first tab portion 10A and the fused portion of the second tab portion 20A are separated from each other, and it is possible to prevent the fused portions from coming into contact with each other again. Further, the fused portion of the first tab portion 10A and the fused portion of the second tab portion 20A are held in a separated state by the shrinkage of the heat shrinkable member 40. As used herein, the “center C of the connecting portion 30A” means an intersection of a bisector (imaginary line Lx) that bisects the dimension 30L of the connecting portion 30A in the Y direction in FIG. 4A and a bisector (imaginary line Ly) that bisects a region R3 (see FIG. 4B) of the heat shrinkable member 40 to be described later in the X direction as viewed along the Z direction.

As an embodiment of the tab 1 of the present disclosure, in the aspect shown in FIGS. 4A and 4B, an outer side (lower side 10d in FIG. 4A) of the first tab portion 10A, which is arranged on one side in the Y direction of the portion covered with the heat shrinkable member 40 and extends along the X direction, may be arranged on one side in the Y direction of the second tab portion 20A and displaced in the Y direction as viewed along the Z direction with respect to an outer side (lower side 20d in FIG. 4A) extending along the X direction. Specifically, the portion of the first tab portion 10A covered with the heat shrinkable member 40 may be displaced from the second tab portion 20A in the −Y direction. As described above, by shifting the first tab portion 10A in the Y direction with respect to the second tab portion 20A, it is possible to prevent re-contact between the fused portion of the first tab portion 10A and the fused portion of the second tab portion 20A.

In the tab 1A of the first embodiment shown in FIG. 4B, the portion covered with the heat shrinkable member 40 in the first tab portion 10A may have a dimension 10L1 in the Y direction decreasing toward the connecting portion 30A as viewed along the Z direction, and the second tab portion 20A may have a dimension 20L in the Y direction decreasing toward the connecting portion 30A as viewed along the Z direction. In other words, an outer edge 10e on the connecting portion 30A side of the portion covered with the heat shrinkable member 40 in the first tab portion 10A may be inclined with respect to the imaginary line Ly extending in the Y direction, and an outer edge 20e on the connecting portion 30A side of the second tab portion 20A may be inclined with respect to the imaginary line Ly extending in the Y direction (see FIG. 4A). According to such a configuration, since the dimensional change of the portion of the first tab portion 10A covered with the heat shrinkable member 40 and the second tab portion 20A in the Y direction gradually decreases, the electric resistance value gradually increases, and the connecting portion 30A has a shape that is likely to be heated due to overcurrent. Therefore, the heat shrinkable member can be easily shrunk. In addition, since the dimensional change of the first tab portion 10A and the second tab portion 20A in the Y direction gradually changes, the heat shrinkable member can be easily inserted when the heat shrinkable member 40 is to be inserted into the first tab portion 10A and the second tab portion 20A at the time of manufacturing the tab.

Note that the aspects of the first tab portion 10A and the second tab portion 20A are not limited to those illustrated in FIGS. 4A and 4B. For example, as illustrated in FIG. 6, the outer edge 10e of a portion of the first tab portion 10A covered with the heat shrinkable member 40 on the connecting portion 30A side may be along the Y direction, and the outer edge 20e of the second tab portion 20A on the connecting portion 30A side may be along the Y direction. As illustrated in FIG. 6, in a case where the outer edge 10e and the outer edge 20e are along the Y direction, the dimensional change of the first tab portion 10A and the second tab portion 20A in the Y direction can be made steep, and the current flowing through the connecting portion 30A can be easily concentrated. In addition, the use amount of the heat shrinkable member 40 can be reduced by decreasing the covering range of the heat shrinkable member 40.

As the minimum required covering aspect of the heat shrinkable member 40 in the tab 1A of the first embodiment, in a case where the heat shrinkable member 40 covers at least a part of the connecting portion 30A, the first tab portion 10A, and the second tab portion 20A, an effect of trapping a spark (metal vapor or molten metal) during fusing by the heat shrinkable member 40 can be exhibited. As a more preferable covering aspect of the heat shrinkable member 40, as shown in FIG. 4B, it is preferable that a region R1 of the heat shrinkable member 40 covering the first tab portion 10A is wider than the region R3 of the heat shrinkable member 40 covering the connecting portion 30A as viewed along the Z direction. In addition, it is preferable that a region R2 of the heat shrinkable member 40 covering the second tab portion 20A is wider than the region R3 of the heat shrinkable member 40 covering the connecting portion 30A as viewed along the Z direction. As described above, by making the region R1 of the heat shrinkable member 40 covering the first tab portion 10A (or the region R2 of the heat shrinkable member covering the second tab portion 20A) wider than the region R3 of the heat shrinkable member 40 covering the connecting portion 30A, it is possible to absorb the positional deviation when the heat shrinkable member is incorporated into the tab and the deviation due to vibration and impact in actual use.

In the dimensional relationship between the first tab portion 10A and the connecting portion 30A, the dimension 30L of the connecting portion 30A in the Y direction may be ½ or less of the dimension 20L of the second tab portion 20 in the Y direction (see FIG. 4A). With such a dimensional relationship, in a case where an overcurrent flows through the connecting portion 30A, the connecting portion can be more appropriately fused.

In the dimensional relationship between the first tab portion 10A and the second tab portion 20A, the dimension 10L1 in the Y direction of the portion covered with the heat shrinkable member 40 in the first tab portion 10A and the dimension 20L in the Y direction of the second tab portion 20A may be the same (see FIG. 4A). According to such a configuration, as shown in FIG. 5, in a case where the connecting portion 30 is fused by the overcurrent, the heat shrinkable member 40 is shrunk, and the fused portion of the first tab portion 10A and the fused portion of the second tab portion 20A are held in a separated state, the first tab portion and the second tab portion can be appropriately held by the heat shrinkable member. Specifically, when the connecting portion 30A is fused, the heat shrinkable member 40 shrinks in the +Y direction to act in a direction in which the lower side 10d of the first tab portion 10A (see FIG. 5) and an upper side 20u of the second tab portion 20A (see FIG. 5) approach each other. That is, the lower side 10d of the first tab portion 10A moves in the +Y direction, and the upper side 20u of the second tab portion 20A moves in the −Y direction. Then, the first tab portion 10A side of the connecting portion 30 and the second tab portion 20A side of the connecting portion 30 is held separately from each other in a state where the first tab portion 10A side is held upward and the second tab portion 20A side is held downward. The configuration is not limited to the case where the dimension 10L1 in the Y direction of the portion of the first tab portion 10A covered with the heat shrinkable member 40 is equal to the dimension 20L in the Y direction of the second tab portion 20. For example, the difference between the dimension in the Y direction of the first tab portion 10A and the dimension in the Y direction of the second tab portion 20A may be within 50% with respect to the larger one of the dimensions in the Y direction of the first tab portion 10A and the dimension in the Y direction of the second tab portion 20A. In a case where the dimensional difference is about the above difference, the amount of shrinkage of the heat shrinkable member is larger than the above difference, so that it is possible to appropriately hold the first tab portion and the second tab portion by the heat shrinkable member.

A dimension 10L2 of the first tab portion 10A in the Y direction at a position not covered with the heat shrinkable member 40 may be equal to or greater than the dimension 20L of the second tab portion 20A in the Y direction (see FIG. 4A). When the dimension 10L2 is equal to or greater than the dimension 20L, the conductive performance of the tab can be improved. The dimension 10L2 may be determined in consideration of interference with components other than the tab, material cost, and the like.

As a further additional configuration of the tab 1A of the first embodiment, the first tab portion 10A may include a covered portion 11 covered with the heat shrinkable member 40 and an uncovered portion 12 not covered with the heat shrinkable member 40 as viewed along the Z direction (see FIGS. 4A and 4B). The uncovered portion 12 may be disposed at a position adjacent to the heat shrinkable member 40 in the Y direction when the tab 1A is viewed along the Z direction. More specifically, the uncovered portion 12 may be disposed so as to be separated from the covered portion 11 and adjacent to each other in the Y direction. Further, the uncovered portion 12 may be provided so as to extend in the +X direction. The heat shrinkable member 40 may be disposed so as to be sandwiched between the covered portion 11 and the uncovered portion 12. In a case where the uncovered portion 12 is provided on the first tab portion 10A, as illustrated in FIG. 5, when the connecting portion 30A is fused by overcurrent and the heat shrinkable member 40 shrinks, the rotation of the heat shrinkable member 40 can be restricted by the uncovered portion 12. As a result, it is possible to reduce the positional deviation due to the rotation of the tab 1A of the present embodiment. It is desirable that the distance between the uncovered portion 12 and the covered portion 11 in the Y direction (see FIG. 5) is slightly greater than a thickness T of the heat shrinkable member 40 (see FIG. 3). Specifically, it is more preferable that the distance between the uncovered portion 12 and the covered portion 11 is equal to or greater than the thickness of the heat shrinkable member 40 (T or more) and equal to or less than 5 times the thickness of the heat shrinkable member 40 (5T or less). This is because, if the distance between the uncovered portion 12 and the covered portion 11 is greater than 5T, vibration or the like may be transmitted in the normal state of the battery pack BP, so that the arrangement of the heat shrinkable member 40 may change. In addition, if the distance between the uncovered portion 12 and the covered portion 11 is narrower than the thickness T of the heat shrinkable member 40, it is difficult to incorporate the heat shrinkable member 40 into the tab. Therefore, the interval between the uncovered portion 12 and the covered portion 11 may be appropriately set as the above numerical range (the thickness T or more and 5T or less of the heat shrinkable member 40).

The lower limit of the length of the uncovered portion 12 in the +X direction is preferably set to be about 2 mm. If the uncovered portion 12 is about 2 mm, the heat shrinkable member 40 can be disposed so as to be sandwiched between the uncovered portion 12 and the covered portion 11. In addition, as illustrated in FIG. 4B, the upper limit of the length of the uncovered portion 12 in the +X direction is preferably set to be a length D1 along the X direction from a position O of the root of the uncovered portion 12 to the insertion portion 20I in plan view. By setting the upper limit of the uncovered portion 12 to be the length D1, the rotation of the heat shrinkable member 40 can be appropriately restricted by the uncovered portion 12. Insulation between the uncovered portion 12 and the second tab portion 20A may be secured by the heat shrinkable member 40.

As a more specific configuration of the tab 1A of the first embodiment, as shown in FIGS. 4A and 4B, the first tab portion 10A may extend on the −Y direction side with respect to the connecting portion 30A as viewed along the Z direction. The second tab portion 20A may extend on a side opposite to the Y direction (+Y direction side) with respect to the connecting portion 30A as viewed along the Z direction. The uncovered portion 12 may be arranged on the −Y direction side with respect to the connecting portion 30A as viewed along the Z direction. By setting the positional relationship among the first tab portion 10A, the second tab portion 20A, and the uncovered portion 12 as described above, the heat shrinkable member 40 can be incorporated so as to be sandwiched between the uncovered portion 12 and the covered portion 11. In addition, if vibration or the like is transmitted in the normal state of the battery pack BP, it is possible to make it difficult for the arrangement of the heat shrinkable member 40 to change.

As a further specific configuration of the tab 1A of the first embodiment, as illustrated in FIGS. 4A and 4B, the second tab portion 20A and the covered portion 11 may be in a point-symmetrical relationship with respect to a center C of the connecting portion 30A as viewed along the Z direction. The term “point-symmetrical” as used herein means not only a case where two elements are in a geometrically strict point symmetry relationship, but also a case where when one element is rotated by 180° with respect to the center C, an outer contour of the element overlaps an outer contour of the other element, or each side forming the outer contour is in a parallel relationship between the two elements. Specifically, in FIG. 4A, when the second tab portion 20 is rotated by 180° with respect to the center C, the outer edge 20e of the second tab portion 20 overlaps with the outer edge 10e of the first tab portion 10 or is parallel to each other. Further, the outer side of the second tab portion 20 (the lower side 20d in FIG. 4A) overlaps with the outer side of the first tab portion 10 (the upper side 10u in FIG. 4A) or is in parallel relationship with each other. As described above, in a case where the second tab portion 20A and the covered portion 11 are in a point-symmetrical relationship as viewed along the Z direction, the shrinkage stress can be uniformly applied to the second tab portion 20A and the covered portion 11 by the heat shrinkable member 40.

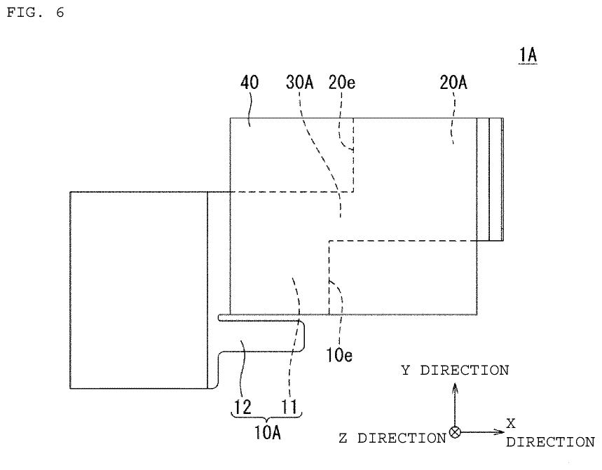

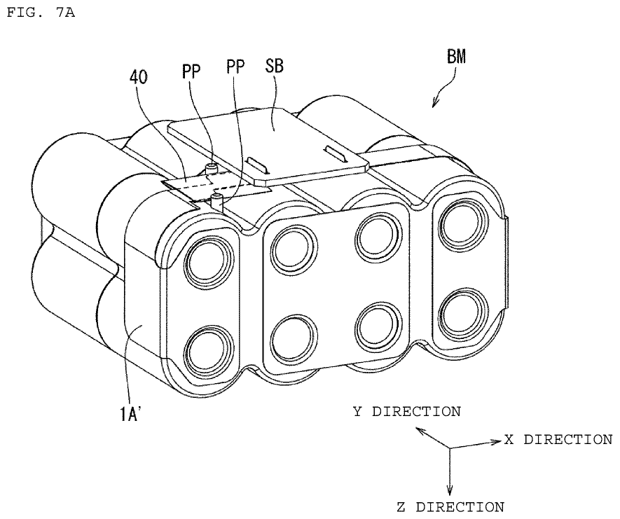

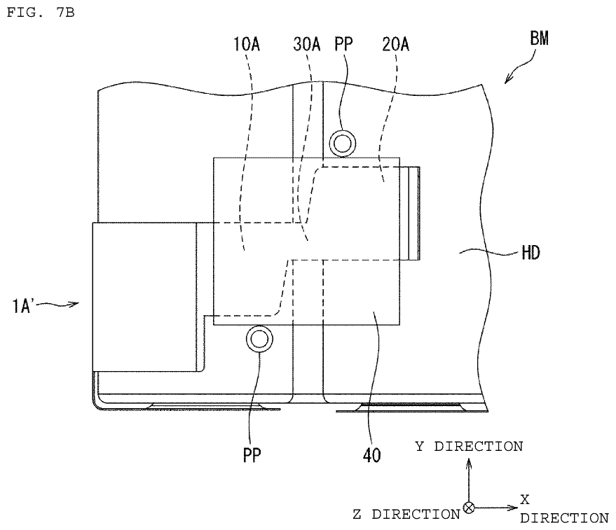

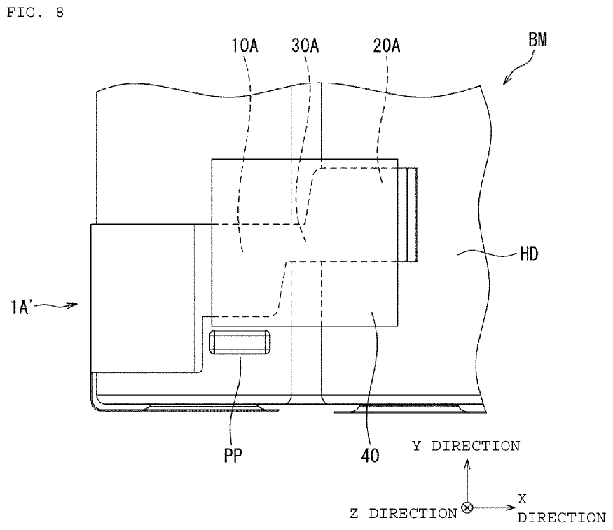

In place of the aspect in which the covered portion 11 and the uncovered portion 12 are provided in the first tab portion 10A described above, a function of preventing rotation of the battery module BM with respect to the battery holder HD may be provided. As an example, as illustrated in FIGS. 7A and 7B, the battery holder HD in which a tab 1A′ is disposed on the outer surface (the back surface on the +Y direction side or the front surface on the −Y direction side) may be adopted with respect to the battery module BM, and the battery holder HD may be provided with a protruding portion PP that is disposed at a position adjacent to the first tab portion 10A in the Y direction, is disposed at a position adjacent to the heat shrinkable member 40 in the Y direction, and protrudes from the outer surface (the top surface on the +Z direction side). In the drawings, the reference sign of a tab not provided with the above-described uncovered portion 12 is 1A′. By providing the protruding portion PP in the battery holder HD, in a case where the connecting portion 30A is fused by overcurrent and the heat shrinkable member 40 shrinks, the rotation of the heat shrinkable member 40 can be restricted by the protruding portion PP. As a result, it is possible to reduce the positional deviation due to the rotation of the tab 1A′ of the present embodiment. Note that the protruding portion PP is not limited to a boss shape having a circular shape as viewed along the Z direction as illustrated in FIGS. 7A and 7B, and may have a rib shape having a quadrangular shape as viewed along the Z direction as illustrated in FIG. 8.

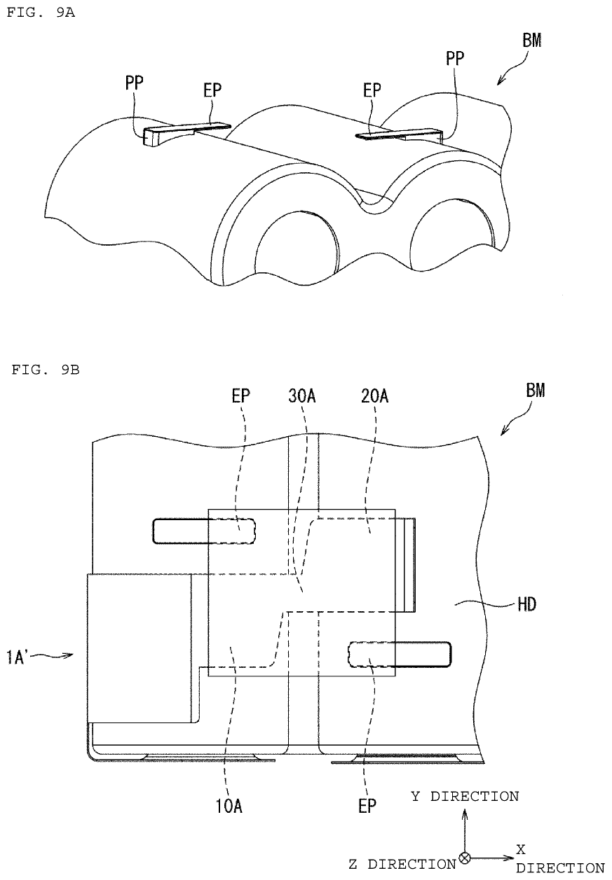

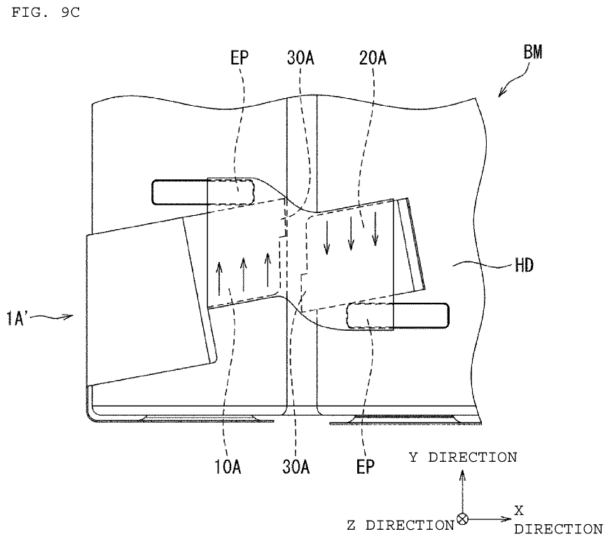

As a preferred aspect of the protruding portion PP provided in the battery holder HD, as shown in FIGS. 9A to 9C, the protruding portion PP may have an extending portion EP extending in the X direction so as to have an L shape when viewed from the Y direction, and at least a part of the extending portion EP may be covered with the heat shrinkable member 40. By adopting an aspect in which the extending portion EP is provided in such a protruding portion PP, in a case where an overcurrent flows through the connecting portion 30A and fusing occurs (see FIG. 9C), heat shrinkage occurs in the heat shrinkable member 40 due to heat caused by the overcurrent, but the heat shrinkage of the heat shrinkable member 40 in contact with the extending portion EP is restricted from shrinking inward of the extending portion EP. The heat shrinkable member 40 not in contact with the extending portion EP is thermally shrunk so as to be in contact with the first tab portion 10A and the second tab portion 20B. Therefore, it is possible to prevent re-contact between the fused portion of the first tab portion 10A and the fused portion of the second tab portion 20A. Further, although stress acts on the first tab portion 10A and the second tab portion 20A in a rotating direction due to heat shrinkage of the heat shrinkable member 40, in a case where the extending portion EP is provided, if the first tab portion 10A and the second tab portion 20A rotate, the rotation is restricted by contact with the extending portion EP. Therefore, if shrinkage stress acts on the first tab portion 10A and the second tab portion 20A, it is possible to prevent re-contact between the fused portion of the first tab portion 10A and the fused portion of the second tab portion 20A.

As described above, according to the tab of the first embodiment, the battery module including the tab, and the battery pack including the battery module, if an overcurrent flows and the connecting portion connecting the first tab portion and the second tab portion is fused, it is possible to prevent re-contact of the fused portions.

Next, a tab 1B of a second embodiment will be described with reference to FIGS. 10A to 12L. Note that, in describing the tab 1B of the second embodiment, description of points common to the description in the item of [Tab of First Embodiment] described above will be appropriately omitted. That is, the following description will focus on points different from the description in the item of [Tab of First Embodiment] described above.

In a broad sense, the tab 1B of the present embodiment is non-line symmetrical as viewed along the Y direction with respect to an imaginary line Lz in which a first tab portion 10B and a second tab portion 20B extend in parallel with the Z direction through the center of a connecting portion 30B (see FIG. 11A). Therefore, as illustrated in FIG. 11B, in a case where an overcurrent flows through the tab 1B and the connecting portion 30B is fused, heat shrinkage of the heat shrinkable member 40 occurs due to heat caused by the overcurrent. As a result, shrinkage stress is applied in a direction in which the fused portion of the first tab portion 10B and the fused portion of the second tab portion 20B are separated from each other, and it is possible to prevent re-contact of the fused portions. Further, the fused portion of the first tab portion 10B and the fused portion of the second tab portion 20B are held in a separated state by the shrinkage of the heat shrinkable member 40.

As an embodiment of the tab 1B of the present embodiment, in the aspect shown in FIGS. 10A to 11A, the first tab portion 10B may include a first protrusion 10p protruding in the −Z direction, and the second tab portion 20B may include a second protrusion 20p protruding to the opposite side of the first protrusion 10p. Specifically, the first protrusion 10p provided on the first tab portion 10B may protrude in the −Z direction (FIGS. 10A to 11A), and the second protrusion 20p provided on the second tab portion 20B may protrude in the +Z direction. As described above, since the first protrusion 10p included in the first tab portion 10B and the second protrusion 20p included in the second tab portion 20B protrude to the opposite sides, as illustrated in FIG. 11B, it is possible to prevent re-contact between the fused portion of the first tab portion 10B and the fused portion of the second tab portion 20B as viewed along the Y direction.

As an aspect of covering the heat shrinkable member in the tab 1 of the second embodiment, as shown in FIGS. 10A to 11A, the heat shrinkable member 40 may cover the first protrusion 10p and the second protrusion 20p. According to such a configuration, as illustrated in FIG. 11B, in a case where thermal shrinkage occurs in the heat shrinkable member 40, thermal shrinkage occurs along the first protrusion 10p and the second protrusion 20p covered by the heat shrinkable member 40, so that it is possible to prevent re-contact between the fused portion of the first tab portion 10B and the fused portion of the second tab portion 20B as viewed along the Y direction.

As a preferred aspect of the first protrusion 10p and the second protrusion 20p, the first protrusion 10p may be provided over the entire Y direction, and the second protrusion 20p may be provided over the entire Y direction (see FIGS. 10A to 10B). According to such a configuration, since the areas of the first protrusion 10p and the second protrusion 20p covered by the heat shrinkable member 40 extend over the entire Y direction, it is possible to appropriately prevent re-contact between the fused portion of the first tab portion and the fused portion of the second tab portion as viewed along the Y direction.

As a more preferable aspect of the first protrusion 10p and the second protrusion 20p, as illustrated in FIG. 10B, a dimension 10p1 of the first protrusion 10p in the Y direction may be equal to or greater than a dimension 31L of the connecting portion 30B in the Y direction, and a dimension 20p1 of the second protrusion 20p in the Y direction may be equal to or greater than a dimension 31L of the connecting portion 30B in the Y direction. According to such a configuration, the dimension 10p1 of the first protrusion 10p and the dimension 20pl of the second protrusion 20p can be set to appropriate dimensions for preventing re-contact of the fused portions.

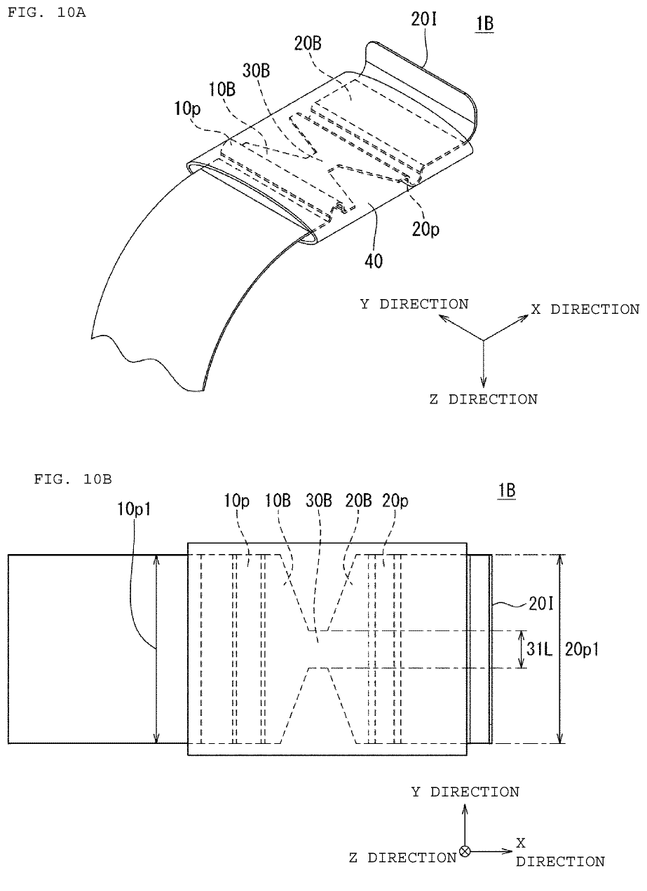

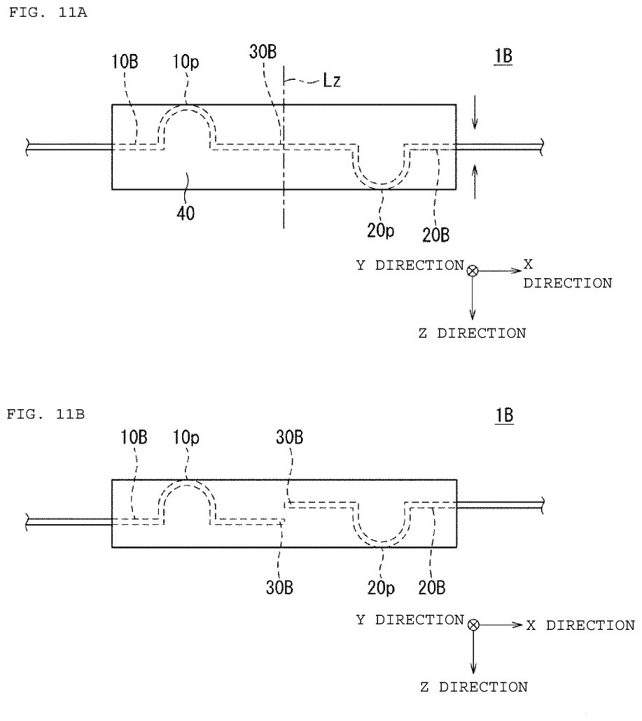

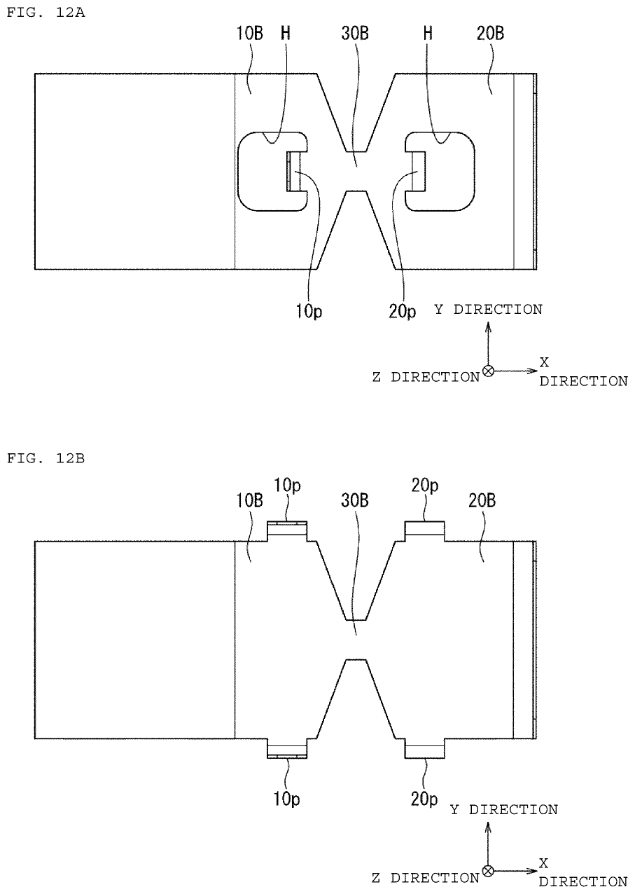

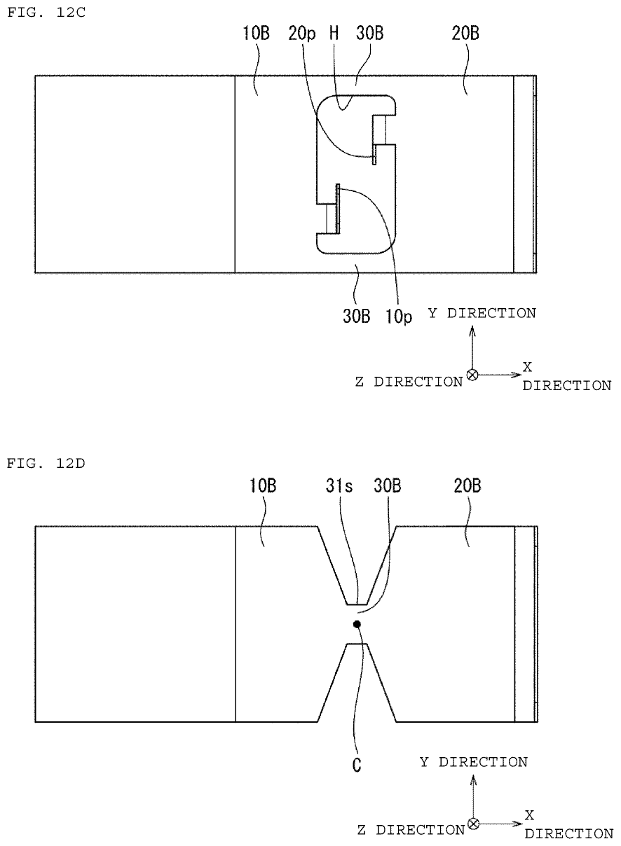

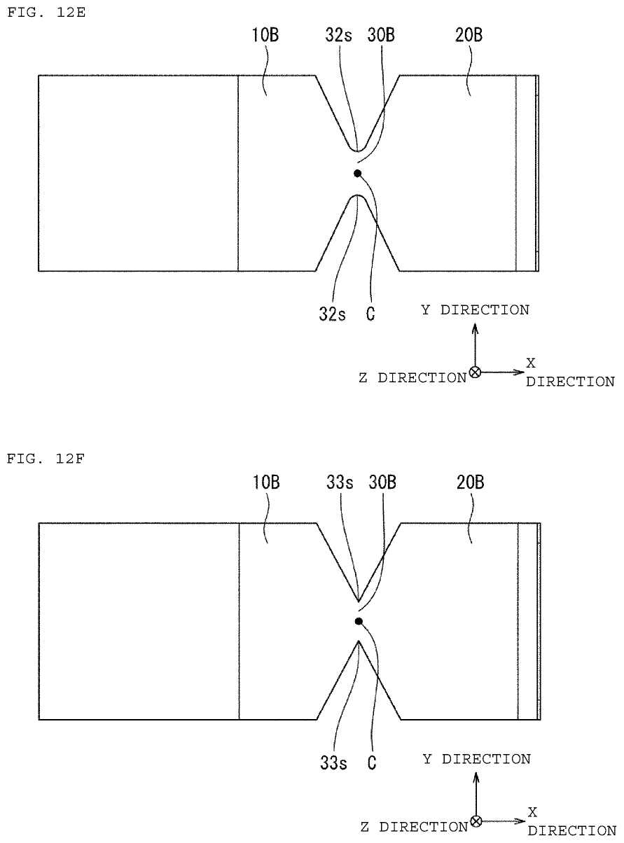

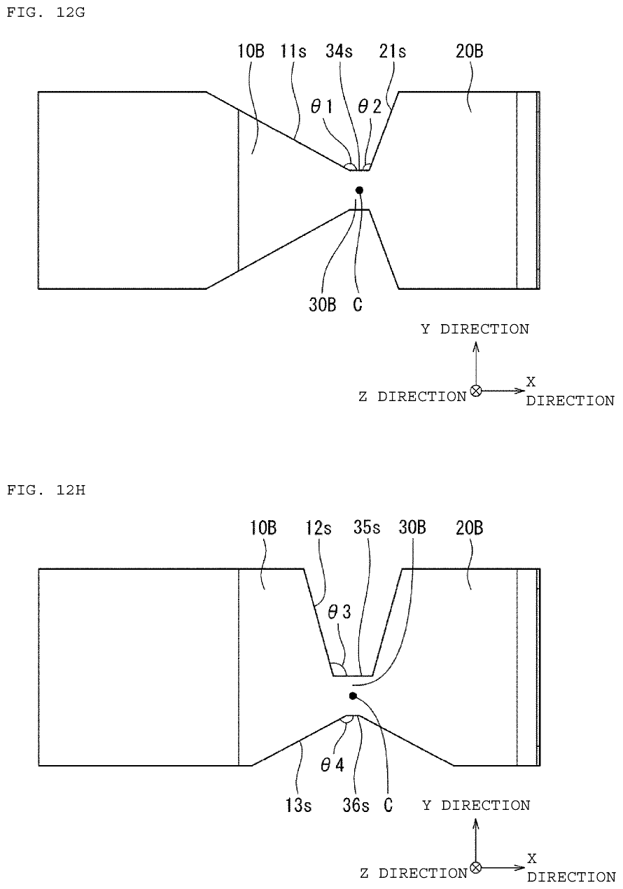

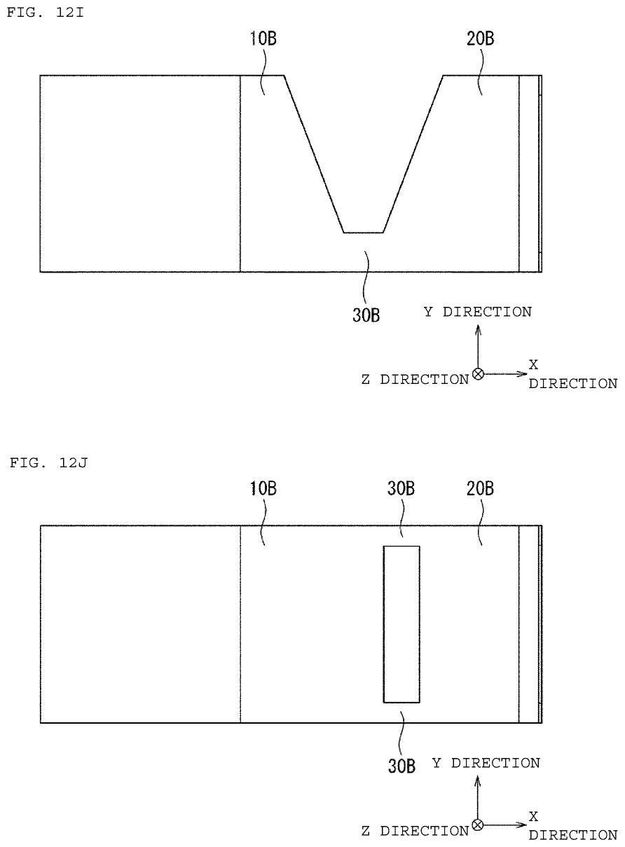

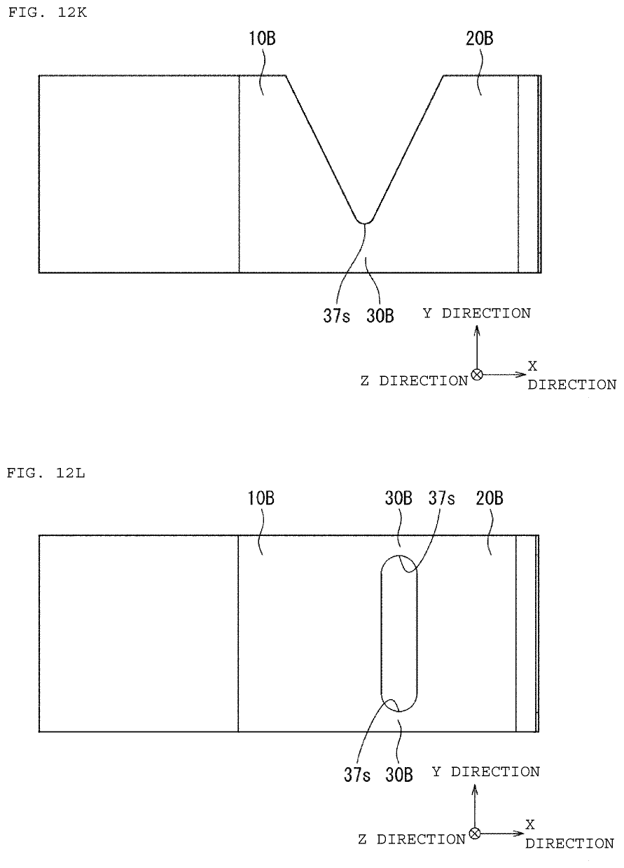

Next, a modification of the tab of the second embodiment will be described with reference to FIGS. 12A to 12L. Note that, in describing the modification of the tab of the second embodiment, description of points common to the description in the item of [Tab of Second Embodiment] will be appropriately omitted. That is, the following description will focus on points different from the description in the item of [Tab of Second Embodiment] described above. In FIGS. 12A to 12L, illustration of the heat shrinkable member is omitted.

First, a modification of the shapes of the first protrusion 10p and the second protrusion 20p of the tab 1B of the second embodiment will be described with reference to FIGS. 12A to 12C according to an embodiment.

As illustrated in FIG. 12A, a hole H may be formed at the center of the first tab portion 10B, and the first protrusion 10p may be provided to extend in the −Z direction at the edge portion of the hole H on the connecting portion 30B side. Similarly, a hole H may be formed at the center of the second tab portion 20B, and the second protrusion 20p may be provided to extend in the +Z direction at the edge portion of the hole H on the connecting portion 30B side. The dimension of the first protrusion 10p and the second protrusion 20p in the Y direction may be substantially the same as the dimension of the connecting portion 30B in the Y direction. Even in the aspect of the modification 1, it is possible to appropriately prevent the re-contact between the fused portion of the first tab portion and the fused portion of the second tab portion as viewed along the Y direction.

As illustrated in FIG. 12B, the first protrusions 10p protruding in the −Z direction may be provided on both side surfaces of the first tab portion 10B in the +Y direction, and the second protrusions 20p protruding in the +Z direction may be provided on both side surfaces of the second tab portion 20 in the +Y direction. Further, the first protrusion 10p and the second protrusion 20p may be aligned in the X direction. According to the aspect of the modification 2, in addition to appropriately preventing re-contact between the fused portion of the first tab portion 10B and the fused portion of the second tab portion 20B as viewed along the Y direction, since the first protrusion 10p and the second protrusion 20p are aligned in the X direction, it is also possible to prevent positional deviation between the first tab portion and the second tab portion after fusing.

As shown in FIG. 12C, both end portions of the first tab portion 10B and the second tab portion 20B in the Y direction may be connected by the connecting portion 30B. The first protrusion 10p extending in the −Z direction and the second protrusion 20p extending in the +Z direction may be disposed inside the pair of connecting portions 30B. In other words, the first protrusion 10p and the second protrusion 20p may be disposed so as to overlap the connecting portion 30B when viewed in the Y direction. According to such a configuration, it is possible to appropriately prevent re-contact between the first tab portion and the second tab portion with respect to the vicinity of the center of the tab.

Next, a modification of the shape of the connecting portion 30B of the tab 1B of the second embodiment will be described with reference to FIGS. 12D to 12L. In FIGS. 12D to 12L, illustration of the first protrusion and the second protrusion is omitted according to an embodiment.

As illustrated in FIG. 12D, an outer side 31s arranged in the +Y direction with respect to the center C of the connecting portion 30B may extend along the X direction. In this manner, by extending the outer side 31s of the connecting portion 30B by a desired length along the X direction, it is possible to adjust the value of the current to be fused by the overcurrent in proportion to the length of the outer side 31s. As illustrated in FIG. 12E, an outer side 32s arranged in the +Y direction with respect to the center C of the connecting portion 30B may have an arc shape. By forming the outer side 32s of the connecting portion 30 in an arc shape as described above, disconnection of the connecting portion 30 due to an external force can be appropriately prevented.

As illustrated in FIG. 12F, an outer side 33s arranged in the +Y direction with respect to the center C of the connecting portion 30B may have a V shape. By forming the outer side 33s of the connecting portion 30B in a V shape as described above, it is possible to fuse with a relatively small overcurrent.

As shown in FIG. 12G, an angle θ1 formed by an outer side 11s arranged on one side in the Y direction of the portion covered with the heat shrinkable member in the first tab portion 10B and an outer side 34s arranged in the Y direction with respect to the center C of the connecting portion 30, and an angle θ2 formed by an outer side 21s arranged on one side in the Y direction of the portion covered with the heat shrinkable member in the second tab portion 20B and an outer side 34s arranged in the Y direction with respect to the center C of the connecting portion 30B may be different from each other. With such an angular relationship, the first tab portion 10B and the second tab portion 20B are asymmetrical with respect to the center C of the connecting portion 30B, and the amount of heat generated by overcurrent can be controlled.

As illustrated in FIG. 12H, the position of the connecting portion 30B may be displaced from the center of the tab in the Y direction. By shifting the position of the connecting portion 30B in the Y direction as described above, the fusing position of the connecting portion 30B caused by the overcurrent can be set to a desired position. An angle θ3 formed by an outer side 12s arranged on the +Y direction side of the portion covered with the heat shrinkable member in the first tab portion 10B and an outer side 35s arranged in the +Y direction with respect to the center C of the connecting portion 30B, and an angle θ4 formed by an outer side 13s arranged on the −Y direction side of the portion covered with the heat shrinkable member in the first tab portion 10B and an outer side 36s arranged in the −Y direction with respect to the center C of the connecting portion 30B may be different from each other. In such an angular relationship, the first tab portion 10B and the second tab portion 20B are asymmetric with respect to the center C of the connecting portion 30B, and the amount of heat generated by the overcurrent can be controlled.

As shown in FIG. 12I, the connecting portion 30B may be provided continuously along the X direction from the outer edge of the first tab portion 10B and/or the outer edge of the second tab portion 20B. According to such a position of the connecting portion 30B, the fusing position of the connecting portion caused by the overcurrent can be brought close to the outer peripheral edge side. Note that, in the modification 9 illustrated in FIG. 12I, an aspect in which the connecting portion 30B is continuous from the outer edge on one side along the X direction is illustrated; however, as illustrated in FIG. 12J, an aspect in which the connecting portion 30B is continuous from the outer edges on both sides along the X direction may be adopted. According to such a configuration, as compared with the aspect shown in FIG. 12I, it is possible to effectively prevent twisting of the first tab portion 10B and the second tab portion 20B. In addition, with respect to the connecting portion 30B illustrated in FIG. 12I or 12J, as illustrated in FIG. 12K or 12L, an outer side 37s of the connecting portion 30 may be formed in an arc shape in order to appropriately prevent disconnection of the connecting portion 30 due to an external force.

As described above, according to the tab, the battery module including the tab, and the battery pack including the battery module of the second embodiment, if an overcurrent flows and the connecting portion connecting the first tab portion and the second tab portion is fused, it is possible to prevent the re-contact of the fused portions.

Note that the embodiments disclosed herein are considered by way of illustration in all respects, and not considered as a basis for restrictive interpretations. Therefore, the technical scope of the present disclosure is not to be construed only by the above-described embodiments, but is defined based on the description of the claims. In addition, the technical scope of the present disclosure encompasses meanings equivalent to the claims and all modifications within the scope. Specifically, “the tab in which the first tab portion 10 and the second tab portion 20 are non-line symmetrical with respect to the imaginary line Ly extending in the Y direction through the center C of the connecting portion 30 as viewed along the Z direction” of the first embodiment and “the tab in which the first tab portion 10 and the second tab portion 20 are non-line symmetrical with respect to the imaginary line Lz extending in the Z direction through the center C of the connecting portion 30 as viewed along the Y direction” of the second embodiment may be combined. With such aspects of the tab, if an overcurrent flows and the connecting portion is fused, it is possible to prevent re-contact of the fused portions when viewed from the Z direction and when viewed from the Y direction.

Aspects of the tab, the battery module, and the battery pack of the present disclosure are as follows according to an embodiment.
<1> A tab including:
   a first tab portion;
   a second tab portion;
   a connecting portion that connects the first tab portion and the second tab portion; and
   a heat shrinkable member that covers the connecting portion, at least a part of the first tab portion, and at least a part of the second tab portion, wherein
   in a case where a direction in which the first tab portion and the second tab portion are arranged is an X direction,
   a thickness direction of the first tab portion and the second tab portion is a Z direction, and
   a direction perpendicular to each of the X direction and the Z direction is a Y direction,
   a dimension of the connecting portion in the Y direction is smaller than a dimension of the first tab portion in the Y direction and a dimension of the second tab portion in the Y direction, and
   the first tab portion and the second tab portion are non-line symmetrical as viewed along the Z direction with respect to an imaginary line extending in the Y direction through a center of the connecting portion, and/or non-line symmetrical as viewed along the Y direction with respect to an imaginary line extending in the Z direction through a center of the connecting portion.
<2> The tab according to <1>, wherein an outer side arranged on one side in the Y direction and extending along the X direction of a portion of the first tab portion covered with the heat shrinkable member is displaced in the Y direction as viewed along the Z direction with respect to an outer side arranged on the one side in the Y direction and extending along the X direction of the second tab portion.
<3> The tab according to <1> or <2>, wherein
   a dimension of a portion covered with the heat shrinkable member in the first tab portion decreases in the Y direction toward the connecting portion as viewed in the Z direction, and
   a dimension of the second tab portion in the Y direction decreases toward the connecting portion as viewed along the Z direction.
<4> The tab according to any one of <1> to <3>, wherein
   an outer edge on the connecting portion side of the portion covered with the heat shrinkable member in the first tab portion extends along the Y direction, and
   an outer edge on the connecting portion side of the second tab portion extends along the Y direction.
<5> The tab according to any one of <1> to <4>, wherein
   a region of the heat shrinkable member covering the first tab portion is wider than a region of the heat shrinkable member covering the connecting portion as viewed along the Z direction, and
   a region of the heat shrinkable member covering the second tab portion is wider than a region of the heat shrinkable member covering the connecting portion as viewed along the Z direction.
<6> The tab according to any one of <1> to <5>, wherein the dimension of the connecting portion in the Y direction is ½ or less of the dimension of the first tab portion in the Y direction.
<7> The tab according to any one of <1> to <6>, wherein a dimension in the Y direction of a portion of the first tab portion not covered with the heat shrinkable member is greater than the dimension in the Y direction of the second tab portion.
<8> The tab according to any one of <1> to <6>, wherein a dimension in the Y direction of the portion covered with the heat shrinkable member in the first tab portion is equal to the dimension in the Y direction of the second tab portion, or a difference between the dimension in the Y direction of the portion covered with the heat shrinkable member in the first tab portion and the dimension in the Y direction of the second tab portion is within 50% with respect to a larger one of the dimension in the Y direction of the first tab portion and the dimension in the Y direction of the second tab portion.
<9> The tab according to any one of <1> to <8>, wherein
   the first tab portion includes a covered portion that is covered with the heat shrinkable member, and an uncovered portion that is not covered with the heat shrinkable member, as viewed along the Z direction, and
   the uncovered portion is disposed at a position adjacent to the heat shrinkable member in the Y direction as viewed along the Z direction.
<10> The tab according to <9>, wherein
   the first tab portion extends toward the Y direction side with respect to the connecting portion as viewed along the Z direction,
   the second tab portion extends in a direction opposite to the Y direction with respect to the connecting portion as viewed along the Z direction, and
   the uncovered portion is arranged on the Y direction side with respect to the connecting portion as viewed along the Z direction.
<11> The tab according to <10>, wherein the second tab portion and the covered portion are in a point-symmetrical relationship with respect to the center of the connecting portion as viewed along the Z direction.
<12> The tab according to any one of <1> to <11>, wherein
   the first tab portion includes a first protrusion protruding in the Z direction, and
   the second tab portion includes a second protrusion protruding to a side opposite to the first protrusion.
<13> The tab according to <12>, wherein the heat shrinkable member covers the first protrusion and the second protrusion.
<14> The tab according to <12> or <13>, wherein
   the first protrusion is provided over the entire Y direction, and
   the second protrusion is provided over the entire Y direction.
<15> The tab according to any one of <12> to <14>, wherein
   a dimension of the first protrusion in the Y direction is equal to or greater than the dimension of the connecting portion in the Y direction, and
   a dimension of the second protrusion in the Y direction is equal to or greater than the dimension of the connecting portion in the Y direction.
<16> The tab according to any one of <12> to <15>, wherein
   a plurality of the first protrusions are provided on the first tab portion and are aligned with the second protrusion of the second tab portion in the X direction, and
   a plurality of the second protrusions are provided on the second tab portion, and are aligned with the first protrusion of the first tab portion in the X direction.
<17> The tab according to any one of <12> to <16>, wherein an outer side arranged in the Y direction with respect to the center of the connecting portion has an arc shape.
<18> The tab according to any one of <12> to <17>, wherein an angle formed by an outer side arranged on one side in the Y direction of a portion covered with the heat shrinkable member in the first tab portion and an outer side arranged in the Y direction with respect to the center of the connecting portion, and an angle formed by an outer side arranged on one side in the Y direction of a portion covered with the heat shrinkable member in the second tab portion and an outer side arranged in the Y direction with respect to the center of the connecting portion are different from each other.
<19> The tab according to any one of <12> to <18>, wherein a position of the connecting portion is displaced from a center of the tab in the Y direction.
<20> The tab according to any one of <12> to <19>, wherein the connecting portion is continuously provided along the Y direction from an outer edge of the first tab portion and/or an outer edge of the second tab portion.
<21> A battery module including:
   the tab according to any one of <1> to <11>;
   a battery cell electrically connected to the tab; and
   a battery holder that houses the battery cell, and includes the tab on an outer surface thereof, wherein the battery holder has a protruding portion that is disposed at a position adjacent to the first tab portion in the Y direction, is disposed at a position adjacent to the heat shrinkable member in the Y direction, and protrudes from an outer surface.
<22> The battery module according to <21>, wherein
   the protruding portion has an extending portion extending in the Y direction so as to have an L shape in a side view, and
   at least a part of the extending portion is covered with the heat shrinkable member.
<23> A battery module including the tab according to any one of <1> to <18>.
<24> A battery pack including the battery module according to <23>.

The present disclosure can be suitably used as a tab, a battery module, or a battery pack that prevents re-contact of fused portions if an overcurrent flows and a fuse is fused according to an embodiment.

It should be understood that various changes and modifications to the embodiments described herein will be apparent to those skilled in the art. Such changes and modifications can be made in the spirit and scope of the present subject matter and without diminishing its intended advantages. It is therefore intended that such changes and modifications be covered by the appended claims.

1. A tab comprising:
a first tab portion;
a second tab portion;
a connecting portion that connects the first tab portion and the second tab portion; and
a heat shrinkable member that covers the connecting portion, at least a part of the first tab portion, and at least a part of the second tab portion, wherein
in a case where a direction in which the first tab portion and the second tab portion are arranged is an X direction,
a thickness direction of the first tab portion and the second tab portion is a Z direction, and
a direction perpendicular to each of the X direction and the Z direction is a Y direction,
a dimension of the connecting portion in the Y direction is smaller than a dimension of the first tab portion in the Y direction and a dimension of the second tab portion in the Y direction, and
the first tab portion and the second tab portion are one or both of non-line symmetrical as viewed along the Z direction with respect to an imaginary line extending in the Y direction through a center of the connecting portion, and non-line symmetrical as viewed along the Y direction with respect to an imaginary line extending in the Z direction through a center of the connecting portion.

2. The tab according to claim 1, wherein an outer side arranged on one side in the Y direction and extending along the X direction of a portion of the first tab portion covered with the heat shrinkable member is displaced in the Y direction as viewed along the Z direction with respect to an outer side arranged on the one side in the Y direction and extending along the X direction of the second tab portion.

3. The tab according to claim 2, wherein
a dimension of the first tab portion decreases in the Y direction toward the connecting portion as viewed in the Z direction, and
a dimension of the second tab portion in the Y direction decreases toward the connecting portion as viewed along the Z direction.

4. The tab according to claim 2, wherein
an outer edge on the connecting portion side of the portion covered with the heat shrinkable member in the first tab portion extends along the Y direction, and
an outer edge on the connecting portion side of the second tab portion extends along the Y direction.

5. The tab according to claim 2, wherein
a region of the heat shrinkable member covering the first tab portion is wider than a region of the heat shrinkable member covering the connecting portion as viewed along the Z direction, and
a region of the heat shrinkable member covering the second tab portion is wider than a region of the heat shrinkable member covering the connecting portion as viewed along the Z direction.

6. The tab according to claim 2, wherein the dimension of the connecting portion in the Y direction is ½ or less of the dimension of the first tab portion in the Y direction.

7. The tab according to claim 2, wherein a dimension in the Y direction of a portion of the first tab portion not covered with the heat shrinkable member is greater than the dimension in the Y direction of the second tab portion.

8. The tab according to claim 2, wherein a dimension in the Y direction of the portion covered with the heat shrinkable member in the first tab portion is equal to the dimension in the Y direction of the second tab portion, or a difference between the dimension in the Y direction of the portion covered with the heat shrinkable member in the first tab portion and the dimension in the Y direction of the second tab portion is within 50% with respect to a larger one of the dimension in the Y direction of the first tab portion and the dimension in the Y direction of the second tab portion.

9. The tab according to claim 2, wherein
the first tab portion includes a covered portion that is covered with the heat shrinkable member, and an uncovered portion that is not covered with the heat shrinkable member, as viewed along the Z direction, and
the uncovered portion is disposed at a position adjacent to the heat shrinkable member in the Y direction as viewed the along the Z direction.

10. The tab according to claim 9, wherein
the first tab portion extends toward the Y direction side with respect to the connecting portion as viewed along the Z direction,
the second tab portion extends in a direction opposite to the Y direction with respect to the connecting portion as viewed along the Z direction, and
the uncovered portion is arranged on the Y direction side with respect to the connecting portion as viewed along the Z direction.

11. The tab according to claim 10 wherein the second tab portion and the covered portion are in a point-symmetrical relationship with respect to the center of the connecting portion as viewed along the Z direction.

12. The tab according to claim 1, wherein
the first tab portion includes a first protrusion protruding in the Z direction, and
the second tab portion includes a second protrusion protruding to a side opposite to the first protrusion.

13. The tab according to claim 12 wherein the heat shrinkable member covers the first protrusion and the second protrusion.

14. The tab according to claim 12, wherein
the first protrusion is provided over the entire Y direction, and
the second protrusion is provided over the entire Y direction.

15. The tab according to claim 12, wherein
a dimension of the first protrusion in the Y direction is equal to or greater than the dimension of the connecting portion in the Y direction, and
a dimension of the second protrusion in the Y direction is equal to or greater than the dimension of the connecting portion in the Y direction.

16. The tab according to claim 12, wherein
a plurality of the first protrusions are provided on the first tab portion and are aligned with the second protrusion of the second tab portion in the X direction, and
a plurality of the second protrusions are provided on the second tab portion, and are aligned with the first protrusion of the first tab portion in the X direction.

17. The tab according to claim 12, wherein an outer side arranged in the Y direction with respect to the center of the connecting portion has an arc shape.

18. The tab according to claim 12, wherein an angle formed by an outer side arranged on one side in the Y direction of a portion covered with the heat shrinkable member in the first tab portion and an outer side arranged in the Y direction with respect to the center of the connecting portion, and an angle formed by an outer side arranged on one side in the Y direction of a portion covered with the heat shrinkable member in the second tab portion and an outer side arranged in the Y direction with respect to the center of the connecting portion are different from each other.

19. The tab according to claim 12, wherein a position of the connecting portion is displaced from a center of the tab in the Y direction.

20. The tab according to claim 12, wherein the connecting portion is continuously provided along the Y direction from an outer edge of the first tab portion and/or an outer edge of the second tab portion.

21. A battery module comprising:
the tab according to claim 2;
a battery cell electrically connected to the tab; and
a battery holder that houses the battery cell, wherein
the battery holder has a protruding portion that is disposed at a position adjacent to the first tab portion in the Y direction, is disposed at a position adjacent to the heat shrinkable member in the Y direction, and protrudes from an outer surface.

22. The battery module according to claim 21, wherein
the protruding portion has an extending portion extending in the X direction so as to have an L shape as viewed from the Y direction, and
at least a part of the extending portion is covered with the heat shrinkable member.

23. A battery module comprising the tab according to claim 2.

24. A battery pack comprising the battery module according to claim 23.
